(19) United States
(12) Patent Application Publication
(10) Pub. No.: US 2007/0181166 A1
(43) Pub. Date: Aug. 9, 2007

(54) Method and agent for removing graffiti

(75) Inventor: Claus Noth, Gladbeck (DE)

Correspondence Address: JAMES C. WRAY, 1493 CHAIN BRIDGE ROAD, SUITE 300, MCLEAN, VA, 22101, US

(73) Assignee: Stephan Ignatzy

(21) Appl. No.: 11/701,005

(22) Filed: Feb. 1, 2007

(30) Foreign Application Priority Data
Feb. 3, 2006 (DE) 10 2006 005 029.0

(51) Int. Cl. B08B 7/00; C11D 17/00

(52) U.S. Cl. 134/42; 510/407

(57) ABSTRACT

For the removal of graffiti 10 a method and removal agent are provided, said agent being comprised of solvents and surface-active agents and present in the form of a gel-like compound, applied to the background surface 3 to be cleaned. This gel-like compound 12 adheres to the background surface, which is moistened slightly beforehand, and makes it possible, after being rubbed in, to dissolve the graffiti 10 and remove it from the background surface 3, so that, once it has been removed, the originally soiled surface is again neutral.

The invention relates to methods for removing paint characterized as graffiti, especially spray paint and similar sprayable materials having intensive coloration, which ordinarily are illegally applied with spray cans to the surfaces of buildings, bridges, advertising posters and similar background surfaces, and frequently include recurrently used symbols intended to serve as the “signature” of the sprayer. The invention further relates to an agent for removing graffiti, in other words for removing spray paints and similar sprayable materials having intensive coloration painted onto the surfaces of buildings, bridges, advertising posters and similar background surfaces, which in some cases are provided with a coating of paint, said agent being applied to these surfaces that are to be cleaned in order to strip off the graffiti.

Graffiti is characterized as slogans, sayings or symbols of a belligerent or comical nature that are sprayed, spattered or painted, primarily with a spray, onto walls, masonry, facades, etc. Although the two-color ornamental or symbolic decorations scratched or scored into stone or marble tiles, which are also characterized as graffiti, are considered art and are viewed as pleasing to people, today's graffiti sprayers have become a real nuisance. Because they apply their sprayed works to corresponding background surfaces unbidden and therefore illegally, mostly at night, they are even pursued by the police, who encounter substantial difficulty in the process. Although such sprayers frequently use recurrent characters and symbols to identify themselves as the authors, they are able to escape quickly under protection of darkness if they are ever caught in their misdeeds by third parties. These offenses are particularly problematic because the spray paints that are used are very difficult to remove and generally cannot be painted over. Furthermore, the paint materials that are used today tend to diffuse into the areas beneath them, in other words especially into the layers of paint, so that a cleaning without damaging the background surface is not possible in practical terms. Attempts have been made using the widest variety of solvents to remove these sprayed misdeeds, for example from railcars and above all from the walls of buildings, as most people do not consider them art or improvement. The drawback of these known removal agents is that they generally also attack the background surface, so that the “cleaned” surface remains identifiable even after being treated, and ordinarily cannot be coated with a new layer of paint without substantial difficulty. Especially in the case of older buildings or older coats of paint, frequently the only way to restore the old attractive condition is to repaint the entire background surface or the entire building, which involves substantial expense.

The object of the invention is thus to create a method for removing graffiti completely without affecting the background surface, and a removal agent for accomplishing this.

The object is attained in accordance with the method in that the surface to be cleaned is moistened with water and, after a brief drying period, a gel-like compound comprised of solvents and surface-active agents is applied to the graffiti, covering the unwanted markings, and in that the compound is allowed to dry during a period of interaction that is appropriate for the background surface, wherein the compound is rubbed into the soiled surface for at least a portion of the period of interaction using auxiliary agents, so that after the previously established period of interaction the compound can be washed off of the soiled surfaces, taking with it the dissolved graffiti.

With a process of this type, moistening with water beforehand ensures that the masonry or plaster beneath the gel-like compound will not dry the compound out prematurely, before it has time to act upon the graffiti.

The gel-like compound, which is comprised of solvents and surface-active agents, is then applied to the unwanted markings and, during the interaction period, which is selected based upon the background surface at hand, is rubbed in using suitable auxiliary agents, in order to purposefully optimize its action on the graffiti. After the predetermined interaction period, which is determined based essentially upon previous experience, the soiled surface is washed, or the gel-like compound with the dissolved graffiti is washed off and thereby removed. Surprisingly, once the cleaned surface has dried, no edges remain, so that the surface that has been cleaned is no longer identifiable. At most it stands out slightly because in the washing process the existing dust has also been cleaned off. In this case, dust must then optionally be removed from the surrounding areas until the area of transition becomes unrecognizable. It is further advantageous that with the proper period of interaction, those portions of the graffiti that have “eaten into” the background surface are also removed, because the gel-like compound comprised of solvents and surface-active agents also takes up these components, thereby removing them from the background surface. Finally, it is advantageous that the materials that are used are gentle on the environment and even environmentally friendly, especially since they are easy to collect and purposefully dispose of, if the environmental authorities require this. By washing the material off or even by optionally blowing it dry with a corresponding drying effect, the material can be purposefully collected and further treated as needed.

One useful further development of the invention provides that warm water be used to moisten the soiled surface. On one hand, this makes it possible for highly absorbent background surfaces to be made neutral, and on the other hand, temperature differences or temperatures that are too low can be easily compensated for in this manner, because with the warm water the same conditions always exist more or less, at least in the area of the background surface. This can be purposefully affected by appropriately adjusting the warm water or by selecting appropriate temperatures.

It is not necessary for the background surface always to be flat, and ordinarily it is not. Especially plastered surfaces always involve a more or less rough surface. In order to ensure an even coverage of the applied graffiti, the invention provides that the gel-like compound be applied in a coating thickness of 0.2 to 5 mm. In a prior testing of the conditions it was easily determined what coating thickness is necessary to compensate for existing roughness and thus also to reliably cover and then clean all areas of the background surface with the gel-like compound.

It has been determined that it is particularly expedient to apply the gel-like compound to the background surface using a wall brush or a scrubbing brush or even a smoothing trowel, and to distribute it to produce an even coating. Using a wall brush or even a scrubbing brush, the described protruding parts of a roughened surface can also be covered; the same applies to smoothing trowels, if one especially takes into account the predetermined roughness. What is important and attainable with these described process steps is that an always even and therefore reliable coverage of the surface of the graffiti to be removed is achieved.

It was further indicated above that it is correct and important to rub the perpetually gel-like compound in during the period of interaction, wherein it is also provided that the gel-like compound, after application and after a brief period of interaction, is rubbed into the soiled surface until the unwanted markings begin to dissolve. In this connection it is advantageous that the gel-like compound is colorless to slightly bluish, so that the intense coloration of the graffiti makes it easy to tell when it has been dissolved by the gel-like compound and removed from the background surface. These can then, as described above, be washed off together at the end of the period of interaction.

As a rule, it is sufficient for the gel-like compound to be removed from the previously soiled surface after 2 to 15 minutes using a moist rag or sponge, since the graffiti that is used generally forms only a very thin layer. It can be brought into solution within the described period of time and taken up by the gel-like compound, so that it can then be picked up or removed from the background surface using a moist rag or a moist sponge. As was mentioned above, once the background surface has dried it is easy to recognize the enormous success that treatment with the gel-like compound has produced. If, as a result of carelessness or for some other reason, the gel-like compound should dry out without the successful loosening and removal of the graffiti material in time by intensive rubbing, the invention provides that new, moist gel-like compound is applied to a partially or completely dried compound, and is rubbed in after a brief period of interaction. The gel-like dried compound and the gel-like moist compound then combine intensively with one another, thus enabling the loosening of the graffiti from the background surface, whereby in this process step the rubbing in must be performed immediately after application of the moist, gel-like compound to the dried compound, i.e. without a brief period of interaction.

If a graffiti treatment is to be performed in a corridor, passageway or similar area, or even in interior areas, or if treatment of a problematic background surface is necessary, the invention provides that in the case of clinker construction or some other background surface that is resistant to cleaning, once the gel-like compound has been applied and evenly distributed over said surface, a thin film is applied and after 15 minutes to 24 hours is again removed, removing the gel-like compound with it. Film provides the further advantage that the drying process of the gel-like compound is slowed considerably, so that the solvent in the gel-like compounds increases correspondingly longer (sic) on the illegally applied graffiti, so that the desired result can be reliably achieved. With the applied film a rubbing in becomes very difficult; however with suitable auxiliary agents this is desirable, but no longer absolutely necessary.

In the cleaning of newer surfaces it is beneficial if, as provided by the invention, a small test surface (approximately DIN A4) is treated first, before applying the gel-like compound, in order to allow the experience gained there to be applied in the processing of the entire surface. This is also expedient because the sprayed liquids that are used do not always have the same composition, and it is then possible to determine by means of the test surface whether it is necessary to alter the composition of the gel-like compound, for example by increasing the ratio of solvent.

A particularly beneficial build-up of the layer of removal agent comprised of gel-like compound can be achieved if, as provided according to the invention, the gel-like compound is applied and worked in starting from the bottom and moving toward the top, in other words from the foundation of the building toward the roof. In any case, it should be ensured during treatment that application to the soiled surface does not occur from all sides at the same time, rather as described from the bottom toward the top, in order to optimize the application of a specific coating thickness.

In plexiglass, PVC, and similar materials plasticizers are often used, and thus in the removal of graffiti problems can arise to the extent that the remaining surface becomes roughened. In order to compensate for this, and in order to facilitate the treatment in general, the invention provides that in the case of plexiglass, PVC, or similar surfaces made of plastic, once the graffiti has been removed the surface is coated with a lacquer, thus restoring its smooth surface. Appropriately, a liquid plastic similar to the one to which it is applied is used for this.

The stripping or removal of the graffiti layer can be improved by applying the coating in a thinner layer toward the edge of the surface to be cleaned, and allowing it to run out to 0 mm beyond the boundary edge. This means that it is not simply stopped at the boundary edge, rather the transition areas are also painted over with the gel-like compound, thus entirely ensuring that the desired and intended transitionless cleaning effect can be achieved. Depending upon the nature and the composition of the background surface, it is possible to pull off the gel-like compound after it dries, like a type of plastic film, in order thus to treat and to clean the necessary area around the graffiti.

The process further provides that a specific gel-like compound comprised of solvents and surface-active agents is used, specifically a gel-like compound comprised of
5 to 20% N-methyl-2-pyrrolidone,
5 to 20% dipropylene glycol monomethyl ether,
5 to 20% 2-methoxy-2-propanol,
5 to 20% 2-methoxy-1-methylethyl acetate,
<1.5% fatty alcohol polyglycol ether,
5 to 20% heavy naphtha solvent.

### This mixture can then be safely and expediently applied as described as a gel-like compound to the background surface to be cleaned and treated, so that the covered graffiti can be safely taken up and removed.

A corresponding removal agent for graffiti, in other words for spray paint and similar sprayable agents having intense coloration, is a mixture of various solvents and surface-active agents. Such a mixture produces a gel, which can be applied as described below in the process claims to the soiled background surfaces. This type of gel can also be easily transported and stored, so that it is available when needed, and always reliably produces the desired removal of the graffiti.

Specifically it is provided that the agent is a combined viscous gel comprised of at least
5 to 20% N-methyl-2-pyrrolidone,
5 to 20% dipropylene glycol monomethyl ether,
5 to 20% 2-methoxy-2-propanol,
5 to 20% 2-methoxy-1-methylethyl acetate,
<1.5% fatty alcohol polyglycol ether,
5 to 20% heavy naphtha solvent.
   This paste-like liquid can be optimally processed, as described, because it can be applied in a purposeful fashion and in a predetermined and optimal coating thickness to the background surfaces to be cleaned. The components are characterized here as minimum amounts because, depending upon the background surface, the ratios may also be greater than those described here, for example the ratio of N-methyl-2-pyrrolidone may be increased even beyond 20%. With the surface-active agents that are used, the dissolved portions of the graffiti are more easily taken up by the water or by the gel-like compound, so that they can then be safely disposed of, wherein reference is made once again to the process steps mentioned further below.

In cases involving very large surface applications, it can be expedient to reduce the portions of the gel that affect the viscosity to zero for processing using airless devices. Naturally, the remaining parts of the airless device must also be adjusted to this material, in order to ensure a reliable application to the graffiti surfaces despite the decrease in the paste-like components, specifically to avoid the risk that the material will run underneath, covering the background surface in an uncontrolled manner.

Overall, the use of the gel-like material in the described composition is advantageous because with it a safe and even coverage of the graffiti surfaces is possible, and because once the graffiti components have been dissolved they can be safely removed, because they have been incorporated into the gel-like compound. Thus a process and a removal agent that are easy to use and environmentally friendly are created. The corresponding materials are also easy and safe to work with and, when processing instructions are followed, will not cause any harm to the user. It is particularly advantageous that with the gel-like compound, i.e. the removal agent, and by using the process steps, it is possible to clean small and large, smooth and rough surfaces, without the cleaned surface as such being clearly identifiable afterward.

Further details and benefits of the invention are presented in the following description of the attached set of drawings, in which a preferred execution model is presented with the relevant details and individual components identified. The drawings show:

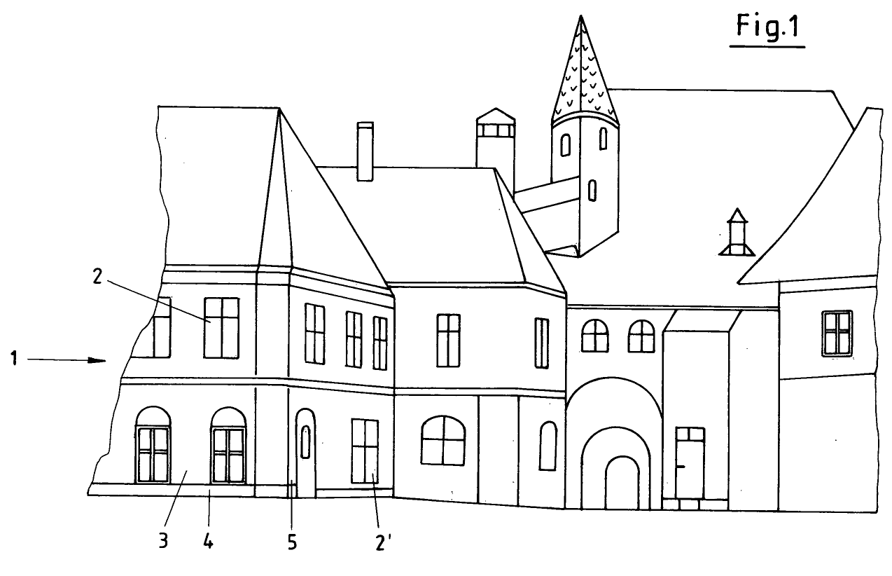

FIG. 1 a view of an old building complex in a clean condition,

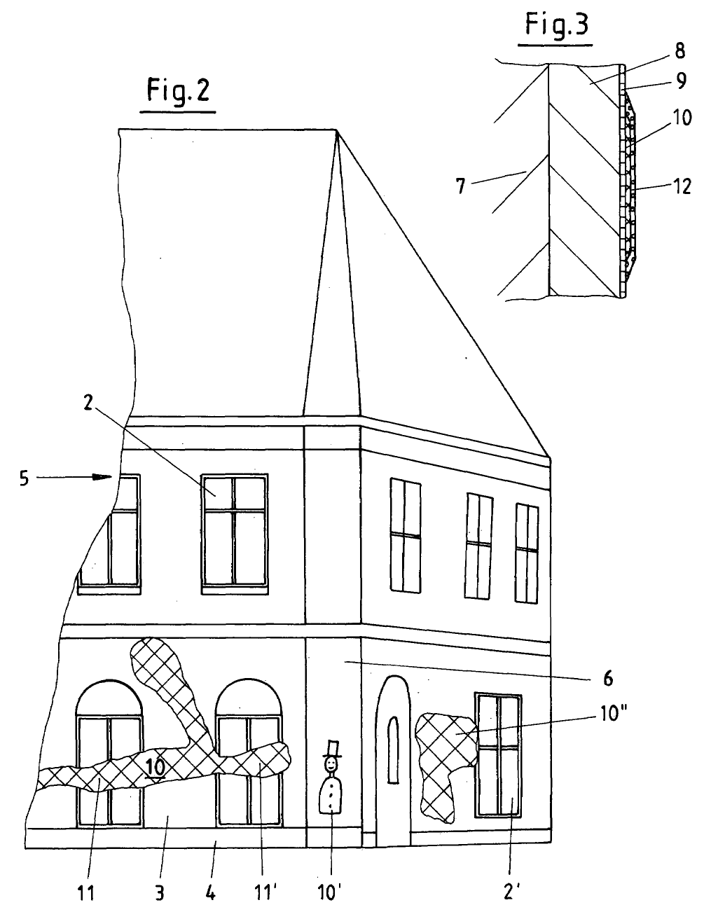

FIG. 2 a plan view (sic) of an individual building with soiled surfaces and

FIG. 3 a cross-section of a section of masonry with a soiled surface.

FIG. 1 shows a building complex 1, which obviously is very old and historic, and which is comprised of multiple individual buildings that are nested into one another and due to their historical significance must be protected. Windows are indicated by 2, 2′, painted surfaces by 3, and the foundations of such a building complex by 4, in order to clarify that this type of building complex 1 contains multiple surfaces that are particularly worthy of protection but are also difficult to clean.

FIG. 2 shows a section of the building complex 1, namely an individual building 5, which is severely soiled and dirtied with graffiti 10. In this case extreme cases are depicted, i.e. even windows 2 are soiled, because the graffiti 10 simply extends over the window surfaces 11, 11′. On a corner surface 6, the sprayer has even succeeded in applying figured graffiti 10′ that is just as difficult to remove as the surface graffiti 10.

While FIG. 1 shows the building complex 1 with the individual building 5 before being soiled and immediately after being soiled (sic), FIG. 3 shows a cross-section of this type of individual building 5 in the area of the graffiti 10. The masonry is indicated by the number 7 and the applied plaster material by the number 8, with the dimensions given here being arbitrarily selected. In any case, it is apparent that a layer of paint 9 has been applied to the plaster material, in this case, for example, a layer of dispersion paint 9. The sprayer has applied a layer of graffiti, indicated by the number 10, to this layer of paint 9, with the graffiti in this case having a smooth surface, although naturally any type of non-smooth surface can be cleaned using the removal agent in the form of the gel-like compound 12. It is apparent that this gel-like compound 12 is applied in a coating thickness that corresponds approximately to that of the graffiti 10. However, it may also be necessary to use a coating thickness that is approximately twice as thick, to ensure that the graffiti 10 can be dissolved. After the disintegration or dissolution and rubbing in of the gel-like compound 12 into the graffiti 10, a unified layer results, which can then be washed off using sponges or rags and water. Afterward, the layer of paint 9 is nearly or entirely present in its original coloration and form, and the original outline or condition of the graffiti layer 10 can no longer be identified.

All the listed characterizing features, including those found only in the set of drawings, alone or in combination, are considered essential to the invention.

1. Method for removing paints characterized as graffiti, especially spray paints and similar sprayable agents having intense coloration, which are ordinarily illegally applied using spray cans to building surfaces, bridges, advertising posters and similar background surfaces, and frequently include recurring symbols that are intended to serve as the “signature” of the sprayer, characterized in that the surface to be cleaned is moistened with water and, after a short drying period, a gel-like compound comprised of solvents and surface-active agents is applied to the graffiti, covering the unwanted markings, in that the compound is allowed to dry for a period of interaction that is chosen based upon the specific background surface, wherein the compound is rubbed in to the soiled surface at least for a time during the period of interaction, using auxiliary agents, so that, after the previously established period of interaction, it can be washed off of the soiled surface, along with the dissolved graffiti.

2. Method according to claim 1, characterized in that warm water is used to moisten the soiled surface.

3. Method according to claim 1, characterized in that the gel-like compound is applied in a coating thickness of 0.2 to 5 mm.

4. Method according to claim 1, characterized in that the gel-like compound is applied to the soiled surface using a wall brush or a scrubbing brush or even a smoothing trowel, and is distributed to create and even coating.

5. Method according to claim 1, characterized in that the gel-like compound, after being applied and after a brief period of interaction, is rubbed into the soiled surface until dissolution of the unwanted marking can be identified.

6. Method according to claim 1, characterized in that the gel-like compound is removed from the previously soiled surface after 2 to 15 minutes using a moist rag or sponge.

7. Method according to claim 1, characterized in that new moist gel-like compound is applied to a partially or completely dried gel-like compound, and is rubbed in after a brief period of interaction.

8. Method according to claim 1, characterized in that in the case of clinker construction or other background surfaces that are resistant to removal, once the gel-like compound has been applied and evenly distributed, a thin film is applied and after 15 minutes up to 24 hours is removed, at which time the gel-like compound is then removed.

9. Method according to claim 1, characterized in that prior to application of the gel-like compound, a small test surface (approximately DIN A4) is treated, in order to allow the experience gained there to be used in treating the entire surface.

10. Method according to claim 1, characterized in that the gel-like compound is applied and worked in from the bottom toward the top, in other words from the foundation of the building toward the roof.

11. Method according to claim 1, characterized in that in the case of a surface comprised of plexiglass or PVC or some similar plastic, once the graffiti has been removed the surface is coated with a lacquer.

12. Method according to claim 1, characterized in that the coating is applied more thinly toward the edge of the surface to be cleaned, and is drawn out over the boundary edge, decreasing to 0 mm.

13. Method according to claim 1, characterized in that a gel-like compound comprised of
5 to 20% N-methyl-2-pyrrolidone,
5 to 20% dipropylene glycol monomethyl ether,
5 to 20% 2-methoxy-2-propanol,
5 to 20% 2-methoxy-1-methylethyl acetate,
<1.5% fatty alcohol polyglycol ether,
5 to 20% heavy naphtha solvent
is used.

14. Removal agent for graffiti, in other words for removing spray paint and similar sprayable materials having intense coloration, from building surfaces, bridges, advertisement posters, and similar background surfaces, which may be covered with a coating of paint, wherein said agent is to be applied to these surfaces to be cleaned for the purpose of removing the graffiti, characterized in that the agent is a mixture of various solvents and surface-active agents.

15. Removal agent according to claim 14, characterized in that the agent is a viscous gel comprised of at least
5 to 20% N-methyl-2-pyrrolidone,
5 to 20% dipropylene glycol monomethyl ether,
5 to 20% 2-methoxy-2-propanol,
5 to 20% 2-methoxy-1-methylethyl acetate,
<1.5% fatty alcohol polyglycols ether,
5 to 20% heavy naphtha solvent.

16. Removal agent according to claim 14, characterized in that the portions of the gel that affect its viscosity are reduced to 0 to allow processing with airless devices.
